(19) United States
(12) Patent Application Publication
(10) Pub. No.: US 2026/0348769 A1
(43) Pub. Date: Nov. 5, 2026

(54) TEMPERATURE SENSOR, PREPARATION METHOD THEREOF AND BATTERY INTEGRATED THEREWITH

(71) Applicant: ROWAY INTELLIGENT TECHNOLOGY (SUZHOU) CO., LTD., Suzhou (CN)

(72) Inventors: Hongfei ZHU, Suzhou (CN); Hongli ZHU, Suzhou (CN); Yayuan SHI, Suzhou (CN); Xiaoxiao FAN, Suzhou (CN)

(73) Assignee: ROWAY INTELLIGENT TECHNOLOGY (SUZHOU) CO., LTD., Suzhou (CN)

(21) Appl. No.: 19/645,283

(22) Filed: Apr. 12, 2026

Related U.S. Application Data
(63) Continuation of application No. PCT/CN2024/124392, filed on Oct. 12, 2024.

(30) Foreign Application Priority Data
Oct. 12, 2023 (CN) 202311316284.0

(51) Int. Cl. G01K 7/16; H01M 50/15; H01M 50/569

(52) U.S. Cl. CPC G01K 7/16; H01M 50/15; H01M 50/569

(57) ABSTRACT

Embodiments of the present disclosure provide a temperature sensor, a method for preparing the temperature sensor, and a battery integrated with the temperature sensor. The temperature sensor includes a bottom electrode, a top electrode, and a poly(3,4-ethylenedioxythiophene) (PEDOT) film and a carbon nanotube film that are intergrown and disposed between the bottom electrode and the top electrode.

### CROSS-REFERENCE TO RELATED APPLICATIONS

This application is a continuation of International Patent Application No. PCT/CN2024/124392, filed on Oct. 12, 2024, which claims priority to the Chinese Patent Application No. 202311316284.0, filed on Oct. 12, 2023, the contents of each of which are hereby incorporated by reference.

### TECHNICAL FIELD

The present disclosure generally relates to the field of battery temperature monitoring technology, and in particular to a temperature sensor, a method for preparing the temperature sensor, and a battery integrated with the temperature sensor.

### BACKGROUND

Lithium batteries are widely used in fields such as power and energy storage due to advantages including high performance, no pollution, and long service life. However, an optimal operating temperature range of the lithium batteries is limited. A temperature that is too low or too high adversely affects discharge performance, service life, or the like of the lithium batteries. To monitor a temperature distribution inside a battery in real time, methods such as using a battery management system (BMS) or fixing a temperature wire on a series-parallel aluminum bar of the battery are typically adopted. However, the accuracy and timeliness of the methods have significant errors.

Therefore, a temperature sensor, a method for preparing the temperature sensor, and a battery integrated with the temperature sensor are needed to quickly, in real time, and accurately obtain temperature distribution data inside the battery.

### SUMMARY

One or more embodiments of the present disclosure provide a temperature sensor. The temperature sensor includes a bottom electrode and a top electrode. The temperature sensor further includes a poly(3,4-ethylenedioxythiophene) (PEDOT) film and a carbon nanotube film. The PEDOT film and the carbon nanotube film are intergrown and disposed between the bottom electrode and the top electrode.

In some embodiments, a thickness ratio of the carbon nanotube film to the PEDOT film is 1:(2.4 to 3.6).

In some embodiments, the thickness ratio of the carbon nanotube film to the PEDOT film is 1:3.

In some embodiments, a thickness of the carbon nanotube film is 0.01 mm to 0.05 mm.

In some embodiments, the thickness of the carbon nanotube film is 0.03 mm.

In some embodiments, the bottom electrode, the top electrode, and the intergrown PEDOT film and carbon nanotube film are encapsulated in an encapsulation material. The encapsulation material includes at least one of epoxy resin, silicone gel, ultraviolet (UV) curing adhesive, polyether ether ketone (PEEK), polyphenylene sulfide (PPS), polyimide (PI), or parylene.

In some embodiments, the encapsulation material further includes at least one of aluminum oxide (Al₂O₃), aluminum nitride (AlN), or polytetrafluoroethylene (PTFE).

In some embodiments, a thickness of the temperature sensor is 0.3 mm to 0.6 mm.

In some embodiments, an interface is formed between the intergrown PEDOT film and the carbon nanotube film for electron transition upon thermal excitation.

In some embodiments, an area of the interface is positively correlated with a temperature sensitivity of the temperature sensor.

In some embodiments, a response time of the temperature sensor is positively correlated with a thickness of the PEDOT film.

In some embodiments, the carbon nanotubes of the carbon nanotube film are selected from high-purity single-walled carbon nanotubes. In some embodiments, the bottom electrode and the top electrode are selected from a carbon nanotube film electrode material, a graphene film electrode material, a screen-printed silver paste electrode material, copper foil, or a flexible printed circuit (FPC) electrode.

In some embodiments, the bottom electrode is formed on a substrate. The substrate is selected from silicon, a mica sheet, or a polymeric material.

One or more embodiments of the present disclosure provide a method for preparing the temperature sensor according to any one of the embodiments of the present disclosure. The method includes forming the bottom electrode on a substrate. The method includes dispersing carbon nanotubes in a medium solution and forming the carbon nanotube film on the bottom electrode by a certain method. The method includes growing the PEDOT film on a surface of the carbon nanotube film by a chemical vapor deposition (CVD) method. The method includes placing the top electrode on the PEDOT film. The method includes encapsulating with an encapsulation material.

In some embodiments, the certain method includes suction filtration, spraying, or film formation.

In some embodiments, the medium solution includes an organic solvent or water. A number of dispersion times is not less than 5. Each dispersion time is not less than 30 s. An ambient temperature is 20 °C to 30 °C.

One or more embodiments of the present disclosure provide a battery. The battery includes a housing, a battery cell, and at least one temperature sensor according to any one of the embodiments of the present disclosure. The at least one temperature sensor is attached to the battery cell and has a signal output terminal extending to an outside of the housing. A battery cover plate is provided at an end of the housing. The signal output terminal adopts a structure built into the battery cover plate or a structure external to the battery cover plate.

In some embodiments, a number of the at least one temperature sensor is a plurality. The plurality of temperature sensors are distributed in an array. Positions of the plurality of temperature sensors constitute temperature sensing points for monitoring temperature at different positions of the battery cell.

In some embodiments, when the signal output terminal adopts the structure external to the battery cover plate, a through-hole is provided on the battery cover plate for the signal output terminal to extend from an inside to an outside. A first sealing structure is provided at the through-hole. The first sealing structure is configured to maintain a sealing property of the signal output terminal. The first sealing structure includes a high-pressure sealing ring, a sealing member, and high-pressure sealing rubber. The high-pressure sealing ring is provided at an outer ring corresponding to an inner side and an outer side of the through-hole. The high-pressure sealing ring at the outer ring is fixed by a sealing nut. The sealing member is embedded in the through-hole. The high-pressure sealing rubber is filled in the sealing member. A hole is provided in the high-pressure sealing rubber for the signal output terminal to pass through. A connection between the signal output terminal and the high-pressure sealing rubber is sealed by silicone gel or epoxy resin curing.

In some embodiments, when the signal output terminal adopts the structure built into the battery cover plate, a quick-connection structure is embedded in the battery cover plate. A sealing material is filled between the quick-connection structure and the battery cover plate. The signal output terminal is inserted into one end of the quick-connection structure. A second sealing structure is provided at a connection position between the quick-connection structure and the signal output terminal. The second sealing structure includes high-pressure sealing rubber.

### BRIEF DESCRIPTION OF THE DRAWINGS

The present disclosure is further described in an illustrative manner by way of exemplary embodiments. These exemplary embodiments are described in detail with reference to the accompanying drawings. These embodiments are not limiting. In these embodiments, the same reference numerals denote the same structures, wherein:

FIG. 1A is a scanning electron microscope (SEM) image of a temperature sensor according to some embodiments of the present disclosure;

FIG. 1B is a scanning electron microscope (SEM) image of an interface where a poly(3,4-ethylenedioxythiophene) (PEDOT) film and a carbon nanotube film are intergrown according to some embodiments of the present disclosure;

FIG. 2 is a spectrum of a composite material of a poly(3,4-ethylenedioxythiophene) (PEDOT) film and a carbon nanotube film according to some embodiments of the present disclosure;

FIG. 3 is a flowchart of an exemplary process for preparing a temperature sensor according to some embodiments of the present disclosure;

FIG. 4 is a schematic diagram of a temperature performance curve of a temperature sensor according to some embodiments of the present disclosure;

FIG. 5 is a schematic diagram of a time-current curve of a temperature sensor according to some embodiments of the present disclosure;

FIG. 6 is a schematic diagram of a time-current curve of a temperature sensor during a temperature holding stage according to some embodiments of the present disclosure;

FIG. 7 is a schematic diagram of a time-current curve of a temperature sensor according to some embodiments of the present disclosure;

FIG. 8 is a schematic diagram of a time-current curve of a temperature sensor during a temperature holding stage according to some embodiments of the present disclosure;

FIG. 9 is a schematic diagram of a time-current curve of a temperature sensor according to some embodiments of the present disclosure;

FIG. 10 is a schematic diagram of a time-current curve of a temperature sensor during a temperature holding stage according to some embodiments of the present disclosure;

FIG. 11 is a schematic diagram of a time-current curve of a temperature sensor according to some embodiments of the present disclosure;

FIG. 12 is a schematic diagram of a time-current curve of a temperature sensor during a temperature holding stage according to some embodiments of the present disclosure;

FIG. 13 is a schematic diagram of a time-current curve of a temperature sensor according to some embodiments of the present disclosure;

FIG. 14 is a schematic diagram of a time-current curve of a temperature sensor during a temperature holding stage according to some embodiments of the present disclosure;

FIG. 15 is a flowchart of an exemplary process for preparing a temperature sensor according to some embodiments of the present disclosure;

FIG. 16 is a schematic structural diagram of a battery integrated with a temperature sensor according to some embodiments of the present disclosure;

FIG. 17 is a schematic diagram of a sealing structure on a battery cover plate according to some embodiments of the present disclosure; and

FIG. 18 is a schematic diagram of a structure for arranging a signal output terminal and a battery cover plate according to some embodiments of the present disclosure.

REFERENCE NUMERALS DESCRIPTION: 100, temperature sensor; 110, bottom electrode; 120, top electrode; 130, film layer; 131, poly(3,4-ethylenedioxythiophene) (PEDOT) film; 132, carbon nanotube film; 140, substrate; 1600, battery; 1601, housing; 1602, battery cover plate; 1603, battery cell; 1604, temperature sensor; 1605, signal output terminal; 1606, through-hole; 1607, first sealing structure; 1608, sealing member; 1609, high-pressure sealing rubber; 1610, hole; 1611, quick-connection structure; 1612, second sealing structure.

### DETAILED DESCRIPTION

To more clearly illustrate the technical solutions of embodiments of the present disclosure, the accompanying drawings to be used in the description of the embodiments will be briefly introduced below. It is apparent that the drawings in the following description are merely some examples or embodiments of the present disclosure, and for a person skilled in the art, without making creative efforts, the present disclosure can also be applied to other similar scenarios based on these drawings. Unless obvious from the context or otherwise specified, the same reference numerals in the drawings represent the same structures or operations.

As shown in the present disclosure and the claims, unless the context clearly indicates an exception, words such as ‘a’, ‘an’, ‘one’, and/or ‘the’ are not exclusively singular, but may also include the plural. Generally speaking, the terms ‘comprising’ and ‘including’ only suggest the inclusion of explicitly identified steps and elements, and these steps and elements do not constitute an exclusive enumeration, and a method or an apparatus may also include other steps or elements. Numerical ranges used herein are for concisely expressing every value included in the ranges.

Flowcharts are used in the present disclosure to illustrate operations performed by a system according to embodiments of the present disclosure. It should be understood that preceding or subsequent operations are not necessarily performed in an exact order. Instead, the various steps may be performed in reverse order or simultaneously. In addition, other operations may also be added to these processes, or one or more steps may be removed from these processes.

With the advancement of technology, the application fields of lithium batteries are also increasingly expanding (e.g., a power field, an energy storage field, or the like), and how to ensure the safe application of lithium batteries has become a very important issue in the new energy industry. It can be understood that, due to the material and performance of the lithium batteries themselves, their optimal operating temperature range is limited (e.g., 25 °C to 40 °C), and thus, over-high temperature and over-low temperature charging and discharging cannot be performed. If in an excessively low temperature state, the diffusion rate of lithium ions in most electrode materials decreases, which leads to the degradation of low-temperature performance of the lithium batteries, and the capacity will also gradually decrease. If in an excessively high temperature state, the chemical equilibrium inside the batteries will be destroyed, the rate of side reactions increases, which leads to a significant reduction in the cycle life of the lithium batteries, and their stability will also decrease. Therefore, controlling the operating ambient temperature of the lithium batteries is crucial, and real-time monitoring of the internal temperature distribution of the lithium batteries is the key to solving the problem.

From a perspective of existing battery temperature monitoring and management technologies, power batteries often rely on BMS to achieve temperature acquisition and real-time monitoring. However, it should be noted that because temperature differences are obvious at various levels of a battery pack when the power battery is running, this will adversely affect the accuracy of battery temperature monitoring and measurement.

The lithium battery is a sealing member, and its internal temperature measurement is difficult. The temperature measurement of the lithium battery is usually performed by fixing temperature lines on series-parallel aluminum busbars of the lithium battery, thereby determining temperature data of the lithium battery during charging and discharging. However, this manner can only measure local external temperatures of the lithium battery, there is an error compared with the real-time internal operating temperature of the lithium battery, and the acquisition and transmission are relatively delayed, which easily affects the timeliness of high-temperature risk alarms.

In view of the above dilemma, an effective solution has not yet been proposed in the industry. How to quickly and real-time obtain the true data of the internal temperature distribution of the battery is a pain point in the current field of lithium battery safety. Therefore, the present application provides a temperature sensor and a method for preparing the temperature sensor, and a battery integrating the temperature sensor, to solve the above problem.

The present disclosure proposes a temperature sensor and a method for preparing the temperature sensor, and a battery integrating the temperature sensor. The temperature sensor comprises a bottom electrode, a top electrode, and a poly(3,4-ethylenedioxythiophene) (PEDOT) film and a carbon nanotube film that are intergrown and disposed between the bottom electrode and the top electrode.

In embodiments of the present application, by interlaced growth of the carbon nanotube film and the PEDOT film, a fully flexible temperature sensor is obtained. The fully flexible temperature sensor has no internal stress, and may be integrated inside a battery cell without damaging electrode materials and diaphragms of the battery, thereby ensuring the safety of the battery and achieving accurate measurement of the real-time internal operating temperature of the battery.

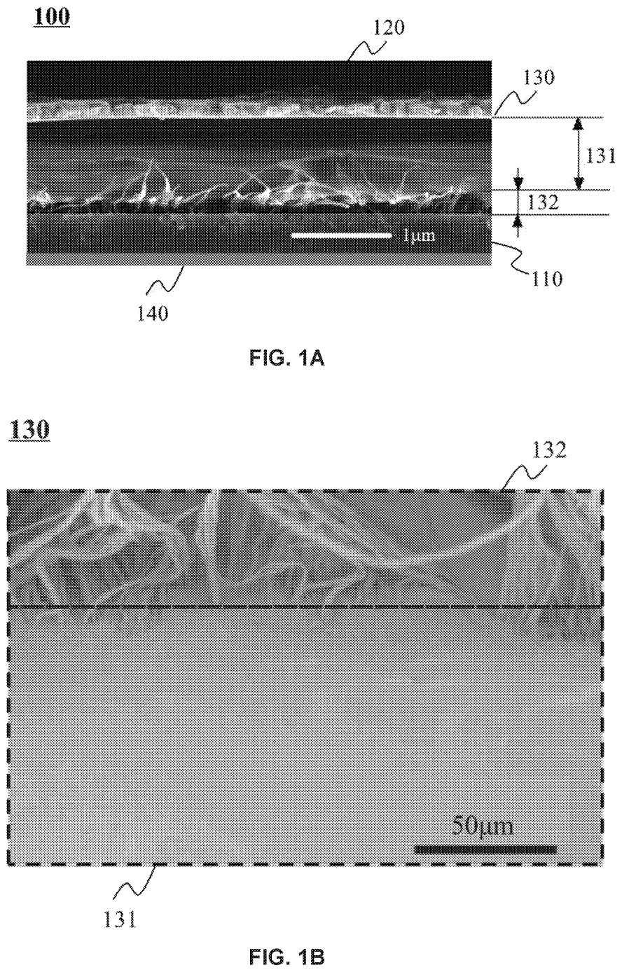

FIG. 1A is a SEM image of a temperature sensor 100 according to some embodiments of the present disclosure. The temperature sensor 100 refers to a sensor that can sense temperature and convert it into an available output signal (e.g., an electrical signal). In some embodiments, the temperature sensor 100 may be a fully flexible temperature sensor. The fully flexible temperature sensor refers to a temperature sensor made of flexible materials, which has good flexibility and ductility. In some embodiments, the temperature sensor 100 may be integrated inside the battery for measuring the internal temperature distribution of the battery.

As shown in FIG. 1A, the temperature sensor 100 may comprise a bottom electrode 110, a top electrode 120, and a film layer 130 between the bottom electrode 110 and the top electrode 120. The bottom electrode 110 refers to an electrode located on one side of a structure of the temperature sensor 100. The bottom electrode 110 may be formed on a substrate 140. In some embodiments, the substrate 140 may be selected from silicon, a mica sheet, or a polymeric material. In some embodiments, the aforementioned polymeric material may include Polyethylene terephthalate (PET), Polycarbonate (PC), Polydimethylsiloxane (PDMS), or the like. The top electrode 120 refers to an electrode located on the other side of the structure of the temperature sensor 100. In some embodiments, the bottom electrode 110 and the top electrode 120 may be used to respond to temperature and convert it into an electrical signal.

In some embodiments, the bottom electrode 110 and the top electrode 120 may be selected from a carbon nanotube film electrode material, a graphene film electrode material, a screen-printed silver paste electrode material, copper foil, or a Flexible Printed Circuit (FPC) electrode.

In some embodiments, the film layer 130 is a fully flexible film and comprises a PEDOT film 131 and a carbon nanotube film 132 which are intergrown. The PEDOT film 131 refers to a film prepared from PEDOT material. The carbon nanotube film 132 refers to a two-dimensional network structure formed by carbon nanotubes. In some embodiments, the carbon nanotubes may be selected from high-purity single-walled carbon nanotubes. FIG. 1B is a SEM image of an interface where the PEDOT film 131 and the carbon nanotube film 132 are intergrown according to some embodiments of the present disclosure. As shown in FIG. 1A and FIG. 1B, the PEDOT film 131 and the carbon nanotube film 132 may be intergrown, and the intergrown interface exists at their junction.

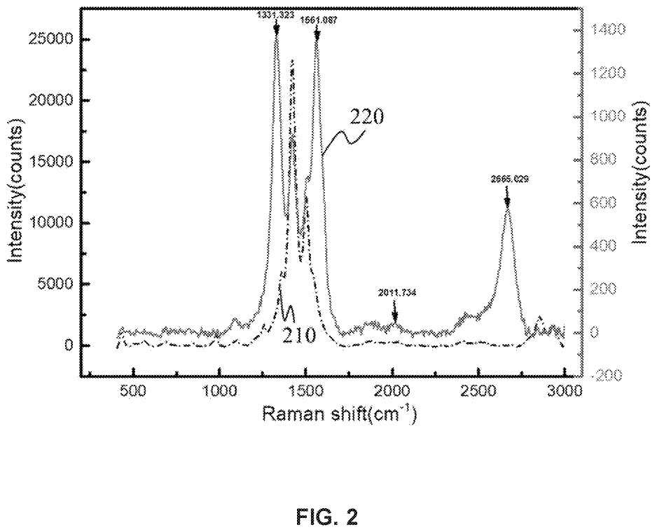

FIG. 2 is a spectrogram of a composite material of the PEDOT film and the carbon nanotube film according to some embodiments of the present disclosure, wherein a spectral line 210 is a spectral line corresponding to the PEDOT material, which includes characteristic spectral peaks (referred to as “characteristic peaks”) of PEDOT; and a spectral line 220 is a spectral line corresponding to the composite material of PEDOT and carbon nanotubes, which includes characteristic peaks of the composite material of PEDOT and carbon nanotubes. As shown in FIG. 2, when the PEDOT film 131 and the carbon nanotube film 132 are intergrown, characteristic peaks (namely, intergrown characteristic peaks) exist. In some embodiments, peak positions of the intergrown characteristic peaks may be located at 1000 cm⁻¹ to 3000 cm⁻¹. Preferably, peak positions of the intergrown characteristic peaks may be located at 1200 cm⁻¹ to 1600 cm⁻¹ and 2000 cm⁻¹ to 2700 cm⁻¹. Preferably, the peak positions of the intergrown characteristic peaks may be located at 1300 cm⁻¹ to 1400 cm⁻¹, 1500 cm⁻¹ to 1600 cm⁻¹, 2000 cm⁻¹ to 2100 cm⁻¹, and 2600 cm⁻¹ to 2700 cm⁻¹. Preferably, the peak positions of the intergrown characteristic peaks may be located at 1331.323 cm⁻¹, 1561.087 cm⁻¹, 2011.734 cm⁻¹, and 2665.029 cm⁻¹.

A thickness ratio of the carbon nanotube film 132 to the PEDOT film 131 has an important influence on the performance of the temperature sensor 100. The PEDOT film 131 being too thin or too thick adversely affects the performance of the temperature sensor 100. When the PEDOT film 131 is too thin, moisture or dust in the air will be adsorbed by the exposed side surfaces of the PEDOT film 131, thereby affecting the electrical conductivity stability of the material. When the PEDOT film 131 is too thick, after electrons transition from the interface, they need to pass through the thicker PEDOT film 131 before being transmitted towards the electrode. During this process, part of the thermal energy will be lost by the PEDOT film 131, and a problem of an excessively long temperature response time will also occur. Therefore, in some embodiments, the thickness ratio of the carbon nanotube film 132 to the PEDOT film 131 is 1:(2.4 to 3.6). Preferably, the thickness ratio of the carbon nanotube film 132 to the PEDOT film 131 may also be 1:(2.6 to 3.4). Preferably, the thickness ratio of the carbon nanotube film 132 to the PEDOT film 131 may also be 1:(2.8 to 3.2).

Preferably, the thickness ratio of the carbon nanotube film 132 to the PEDOT film 131 may be 1:3. By setting the thickness ratio of the carbon nanotube film 132 to the PEDOT film 131 to 1:(2.4 to 3.6), excellent electrical conductivity stability and temperature response time can be obtained. By setting the thickness ratio of the carbon nanotube film 132 to the PEDOT film 131 to 1:3, the relatively optimal electrical conductivity stability and temperature response time in the above ratio range can be obtained.

The thickness of the carbon nanotube film 132 has an important influence on the performance of the temperature sensor 100. The carbon nanotube film 132 being too thin or too thick adversely affects the performance of the temperature sensor 100. In the case where the thickness ratio of the carbon nanotube film 132 to the PEDOT film 131 is fixed, when the carbon nanotube film 132 is too thin, intergrown interfaces of the carbon nanotube film 132 and the PEDOT film 131 are too few, which affects the temperature sensing performance of the temperature sensor 100 (e.g., a decrease in the temperature sensitivity, or the like). When the carbon nanotube film 132 is too thick, although the intergrown interfaces become more numerous, the PEDOT vapor cannot enter the carbon nanotube film 132 and can only grow on its outside, and cannot form a uniformly distributed and continuous material, which also reduces the temperature sensing performance of the temperature sensor 100. Therefore, in some embodiments, a thickness of the carbon nanotube film 132 may be 0.01 mm to 0.05 mm. Preferably, the thickness of the carbon nanotube film 132 may be 0.015 mm to 0.045 mm. Preferably, the thickness of the carbon nanotube film 132 may be 0.02 mm to 0.04 mm. Preferably, the thickness of the carbon nanotube film 132 may be 0.03 mm. By limiting the thickness of the carbon nanotube film 132 to 0.01 mm to 0.05 mm, excellent temperature sensing performance can be obtained (e.g., higher temperature sensitivity, moderate temperature response time, or the like). By limiting the thickness of the carbon nanotube film 132 to 0.03 mm, the relatively optimal temperature sensing performance in the above thickness range can be obtained.

In some embodiments, as shown in FIG. 1A and FIG. 1B, an interface for electron transition upon thermal excitation is formed between the intergrown PEDOT film 131 and the carbon nanotube film 132. It may be understood that PEDOT is a conductive polymeric material. Due to the conjugated double bonds in its molecular structure, which can facilitate electron flow, PEDOT has excellent electron-donating properties. Carbon nanotubes are nanoscale tubular structures composed of carbon atoms, which have excellent electrical and thermal properties. Upon thermal excitation, the electrons in the carbon nanotubes can obtain sufficient energy to undergo a transition, thereby exhibiting excellent transition capability. When the PEDOT film 131 and the carbon nanotube film 132 are combined, the electron-donating properties of the PEDOT and the excellent electron transport and transition capability of the carbon nanotubes are combined, which can form an efficient charge transport channel (namely, the interface for electron transition upon thermal excitation). This can improve the thermoelectric conversion efficiency of the composite material, enabling the electrons to smoothly pass through the PEDOT film 131 to reach the electrodes, while maintaining lower energy loss and a moderate response time during the transition process.

In some embodiments, an area of the interface between the intergrown PEDOT film 131 and the carbon nanotube film 132 is positively correlated with the temperature sensitivity of the temperature sensor 100. The temperature sensitivity refers to a parameter that characterizes the sensitivity of a sensor to temperature changes. For example, a change amount of an output signal of the sensor for a unit temperature change. It may be understood that, the larger the area of the interface, the more channels for electron transition upon thermal excitation, and better electron transport performance, thereby the higher the temperature sensitivity of the temperature sensor 100.

In some embodiments, the temperature sensitivity of the temperature sensor 100 may be improved by increasing the area of the interface. Exemplarily, the manner of increasing the interface area may include the following steps.
Step 1: Modifying a surface of the carbon nanotubes. For example, the surface of the carbon nanotubes may be hydroxylated or carboxylated, so that the catalyst in Step 2 can be loaded on the surface of the carbon nanotubes.
Step 2: Adding a catalyst. In some embodiments, the catalyst may comprise Fe3+. The adding amount and the dispersion degree of the catalyst can affect the interface area. For example, the larger the adding amount of the catalyst and the greater the dispersion degree, the larger the interface area. The PEDOT film 131 may be grown at locations where the catalyst is loaded on the surface of the carbon nanotubes, so that the PEDOT film 131 covers the surface of the carbon nanotubes as much as possible, to form a larger interface area.

In some embodiments, the response time of the temperature sensor 100 is positively correlated with the thickness of the PEDOT film 131. The response time refers to a time from when the temperature sensor 100 receives a temperature change signal to when it outputs a measurement result. The shorter the response time, the more suitable the temperature sensor 100 is for rapidly changing temperature environments. It may be understood that, the thicker the PEDOT film 131, the longer the time required for the electrons to pass through the PEDOT film 131 and then reach the electrodes after transition, and the longer the response time of the temperature sensor 100.

In some embodiments, the bottom electrode 110, the top electrode 120, and the intergrown PEDOT film 131 and carbon nanotube film 132 may be encapsulated in an encapsulation material. The encapsulation material refers to a material that protects, seals, and houses internal components of the temperature sensor 100 (such as the bottom electrode 110, the top electrode 120, the PEDOT film 131, and the carbon nanotube film 132, or the like). In some embodiments, the encapsulation material may be used to isolate the internal components of the temperature sensor 100 from the outside, thereby preventing external factors (such as leakage of electrolyte inside the battery, or the like) from affecting the normal operation of the temperature sensor 100. In some embodiments, the encapsulation material may comprise at least one of epoxy resin, silicone gel, ultraviolet rays (UV) curing adhesive, polyetheretherketone (PEEK), polyphenylene sulfide (PPS), polyimide (PI), or parylene.

In some embodiments, an exemplary encapsulation manner may include:
Step 1: Pretreating the encapsulation material to obtain a flowable encapsulation material. The pretreatment manners may include melting, dissolving, or the like. The flowable states may include a molten state, a liquid state, or the like.
Step 2: Completely immersing the internal components of the temperature sensor 100 into the flowable encapsulation material and then taking them out.
Step 3: Curing the encapsulation material on a surface of the internal components of the temperature sensor 100 to form an encapsulation film, thereby completing the encapsulation.

In some embodiments of the present disclosure, by encapsulating the bottom electrode, the top electrode, and the intergrown PEDOT film and carbon nanotube film in the encapsulation material, the internal components of the temperature sensor can be effectively protected, thereby preventing external factors from affecting the normal operation, the service life, the temperature sensing performance, or the like, of the temperature sensor. By setting the encapsulation material to comprise epoxy resin, silicone gel, UV curing adhesive, PEEK, PPS, PI, or parylene, the temperature sensor inside the battery is enabled to possess the good corrosion resistance, the anti-aging property, the insulation, and the thermal conductivity, or the like, thereby enabling signals to be safely transmitted and ensuring the reliability and timeliness of temperature acquisition.

In some embodiments, the thickness of the encapsulation film may be no more than 0.5 mm. Preferably, the thickness of the encapsulation film may also be 0.2 mm to 0.4 mm. Preferably, the thickness of the encapsulation film may also be 0.3 mm to 0.4 mm. It may be understood that, the temperature sensor 100 needs to be placed in a battery for temperature monitoring. When the encapsulation film is too thick, it will cause a larger distance between internal structures of the battery, thereby affecting the battery performance. By limiting the thickness of the encapsulation film to no more than 0.5 mm, the normal exercise of the battery functions can be ensured.

The encapsulation material may have a heat transfer delay phenomenon due to its poor heat transfer performance. In order to reduce the heat transfer delay, in some embodiments, the encapsulation material may further comprise at least one of Al₂O₃, AlN, or PTFE. These materials may be composited with the aforementioned epoxy resin, silicone gel, PI, or the like, materials to improve the thermal conductivity of the temperature sensor 100 and reduce the heat transfer delay.

In some embodiments, after the encapsulation is completed, the thickness of the temperature sensor 100 may be 0.3 mm to 0.6 mm. Preferably, the thickness of the temperature sensor 100 may also be 0.35 mm to 0.55 mm. Preferably, the thickness of the temperature sensor 100 may also be 0.4 mm to 0.5 mm. Preferably, the thickness of the temperature sensor 100 may also be 0.4 mm to 0.45 mm. In some embodiments of the present disclosure, by limiting the thickness of the temperature sensor 100 to 0.3 mm to 0.6 mm, the overall structure of the temperature sensor 100 can achieve an ultra-thin design, ensuring that the temperature sensor 100 will not cause space compression when operating in the battery cell, thereby reducing safety hazards.

In some embodiments of the present disclosure, by providing the temperature sensor to comprise: a bottom electrode and a top electrode; and an intergrown PEDOT film and a carbon nanotube film between the bottom electrode and the top electrode, an interface for thermal electron transition can be provided, enabling the electrons to smoothly pass through the PEDOT film to reach the electrodes with low energy loss during the process and a moderate response time, thereby enabling the temperature sensor to quickly, accurately, and real-time obtain real temperature distribution data inside the battery. Furthermore, due to the soft characteristics of a fully flexible temperature sensor, the fully flexible temperature sensor generates no additional stress inside the battery cell, and is capable of real-time monitoring the internal operating temperature of the battery without harming the safety of the battery.

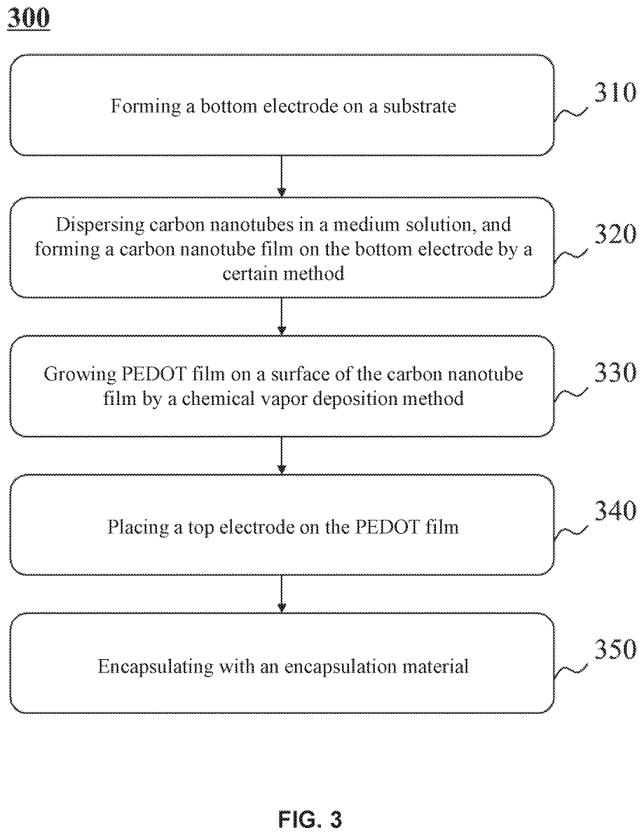

FIG. 3 is a flowchart of an exemplary process for preparing the temperature sensor according to some embodiments of the present disclosure. As shown in FIG. 3, the process 300 includes the following steps.

Step 310, forming the bottom electrode on a substrate. More details regarding the substrate and the bottom electrode may be referred to in the foregoing relevant descriptions.

In some embodiments, the substrate may be prepared by a manner of molding, or the like, based on the substrate parameters. The substrate parameters refer to process parameters related to the substrate. For example, the substrate parameters include substrate size, substrate shape, or the like. The substrate parameters may be preset based on experience or requirements.

In some embodiments, the bottom electrode may be formed on the substrate by a manner of printing, or the like, based on the prepared substrate and a bottom electrode material.

Step 320, dispersing carbon nanotubes in a medium solution, and forming the carbon nanotube film on the bottom electrode by a certain method. More details regarding the carbon nanotube film may be referred to in the foregoing relevant descriptions.

The medium solution refers to a liquid capable of uniformly dispersing carbon nanotubes. In some embodiments, the medium solution may comprise water, an organic solvent (such as ethanol, dichloromethane, or the like).

In some embodiments, exemplary dispersing manners may include milling, ultrasonic treatment, adding a surfactant, or the like. In some embodiments, the dispersing of the carbon nanotubes in the medium solution may be performed based on the dispersing parameters. The dispersing parameters refer to execution parameters related to dispersing. For example, the dispersing parameters include dispersion time, ambient temperature, or the like. The dispersing parameters may be preset based on experience or requirements.

In some embodiments, a number of dispersion times is not less than 5, each dispersion time is not less than 30 s, and an ambient temperature is 20 °C to 30 °C. In some embodiments of the present disclosure, by limiting the dispersing parameters, a better dispersing effect of the carbon nanotubes in the medium solution may be achieved.

In some embodiments, the certain method may comprise suction filtration, spraying, or film formation. By forming the carbon nanotube film on the bottom electrode in diverse manners, a plurality of production requirements and application scenarios may be accommodated.

Step 330, growing the PEDOT film on a surface of the carbon nanotube film by a chemical vapor deposition (CVD) method. More details regarding the PEDOT film may be referred to in the foregoing relevant descriptions.

Step 340, placing the top electrode on the PEDOT film. More details regarding the top electrode may be referred to in the foregoing relevant descriptions.

Step 350, encapsulating with an encapsulation material. More details regarding the encapsulation material and encapsulation manners may be referred to in FIG. 1A and FIG. 1B and their relevant descriptions.

In some embodiments of the present disclosure, by forming the bottom electrode on a substrate; dispersing carbon nanotubes in a medium solution and forming the carbon nanotube film on the bottom electrode by a certain method; growing the PEDOT film on a surface of the carbon nanotube film by a CVD method; placing the top electrode on the PEDOT film; and encapsulating with an encapsulation material, a fully flexible temperature sensor with excellent performance and accurate measurement may be prepared. The temperature sensor has high temperature sensitivity and moderate response time, and is thereby capable of ensuring the reliability and timeliness of battery internal temperature acquisition, such that the battery operates within a safe and efficient temperature range.

Hereinafter, the temperature sensing performance of the temperature sensor will be described in detail through Embodiment 1 and Comparative Example 1 to Comparative Example 4. It should be noted that preparation manners, preparation materials, preparation parameters, or the like, in Embodiment 1 and Comparative Example 1 to Comparative Example 4 are merely for illustrating the performance and the method for preparing the temperature sensor, and do not limit the protection scope of the present application.

### Embodiment 1

This embodiment involves the preparation of the temperature sensor, including the following steps.
Step 1, preparing a substrate and cleaning the substrate, wherein a substrate material of the substrate is selected as PET, the substrate parameters of the substrate are a thickness of 0.18 mm, and the bottom electrode is formed on the substrate by a printing manner.
Step 2, dispersing carbon nanotubes in water by an ultrasonic treatment manner, and after dispersing, forming the carbon nanotube film on the bottom electrode by a spraying method. A number of dispersion times is 5, a single dispersion time is 30 s, an ambient temperature is 25 °C, the carbon nanotubes are selected as metal single-walled carbon nanotubes (M-SWCNTr), a length of the carbon nanotubes is 1 μm, and a thickness of the carbon nanotubes is 0.03 mm.
Step 3, growing a PEDOT film on a surface of the M-SWCNTr film by a CVD method, wherein a thickness ratio of the M-SWCNTr film to the PEDOT film is 1:3 (as shown in FIG. 1A and FIG. 1B, the PEDOT film and the M-SWCNTr film are intergrown).
Step 4, placing the top electrode on the intergrown PEDOT film and M-SWCNTr film (i.e., a PEDOT@M-SWCNTr film).
Step 5, encapsulating with an encapsulation material to form a fully flexible temperature sensor.

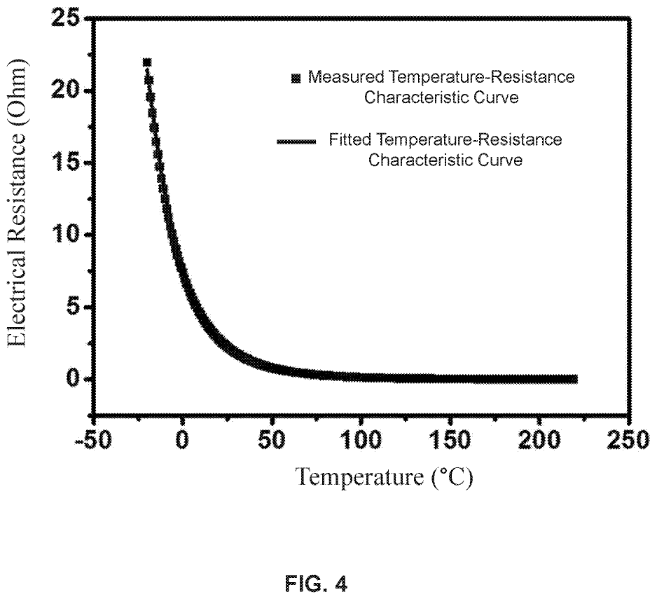

A temperature performance curve of the PEDOT@M-SWCNTr film of Embodiment 1 applied to the temperature sensor is shown in FIG. 4, and the curve function relationship is:

y=0.10+21.77*exp(−(x+20.38)/18.98,

where x represents the ambient temperature, and y represents the temperature sensitivity. After determination, when the ambient temperature is in a range of −19 °C to −20 °C, the temperature sensitivity reaches 5.6%/°C; when the ambient temperature is in a range of 0 °C to 1 °C, the temperature sensitivity reaches 4.9%/°C; when the ambient temperature is in a range of 19 °C to 20 °C, the temperature sensitivity reaches 4.4%/°C; when the ambient temperature is in a range of 49 °C to 50 °C, the temperature sensitivity reaches 3.7%/°C. Typically, a temperature sensitivity of a PEDOT: PSS film is 0.4%/°C, a temperature sensitivity of a carbon nanotube (CNT) film is 0.18%/°C, and a temperature sensitivity of a PEDOT: PSS@CNT film is 0.6%/°C. By comparing the temperature sensitivity of the PEDOT@M-SWCNTr film in Embodiment 1 with the temperature sensitivities of other films, it can be determined that the temperature sensitivity of the PEDOT@M-SWCNTr film in Embodiment 1 can reach about 4%/°C, which is significantly improved compared with other films.

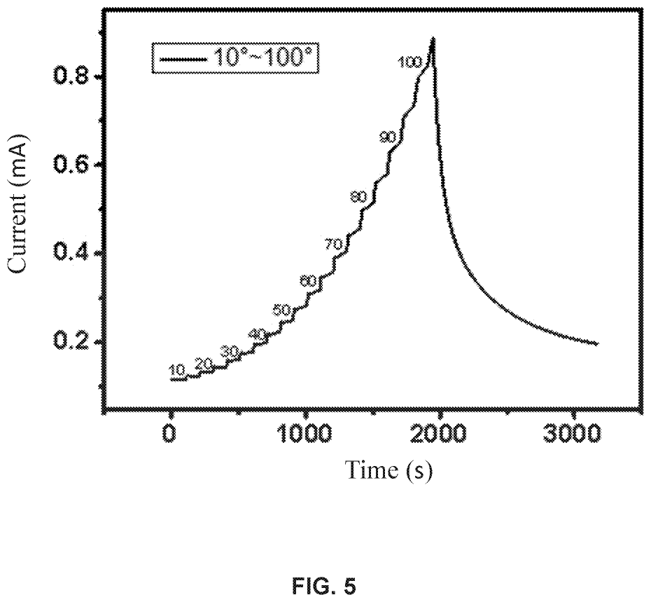

A time-current curve of the temperature sensor corresponding to Embodiment 1 is shown in FIG. 5: it can be determined from FIG. 5 that when the thickness ratio of the PEDOT@M-SWCNTr film is 1:3, the temperature rise curve and the temperature holding stage curve are relatively smooth.

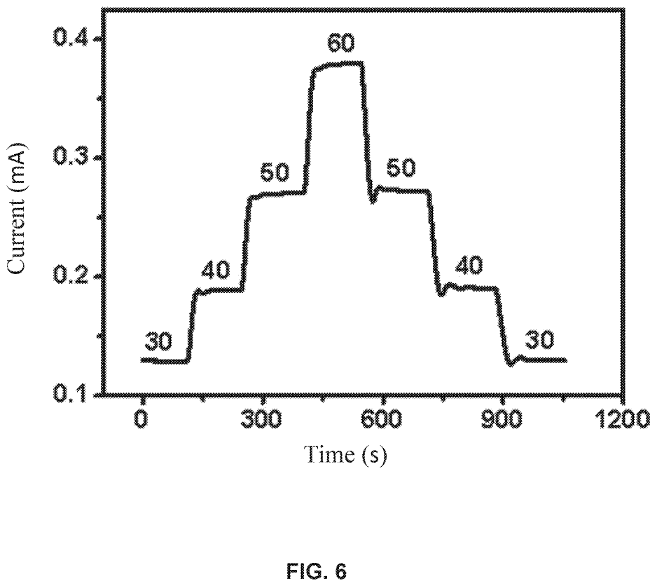

A time-current curve of the temperature sensor corresponding to Embodiment 1 during the temperature holding stage is shown in FIG. 6. It can be determined from FIG. 6 that when the ambient temperature is raised from 30 °C to 60 °C and then lowered to 30 °C, the temperature plateau is maintained relatively stable during the temperature holding stage.

In summary, it can be determined that when a thickness ratio of the carbon nanotube film to the PEDOT film (the PEDOT@M-SWCNTr film) is 1:3, the temperature sensitive composite material applied in the temperature sensor comprises M-SWCNTr, an M-SWCNTr/PEDOT interface, and PEDOT, wherein electrons transition at the M-SWCNTr/PEDOT interface after thermal excitation and are smoothly transmitted to the electrode through the PEDOT film. The temperature sensor corresponding to Embodiment 1 has a moderate response time, high temperature sensitivity, and relatively stable performance.

### Comparative Example 1

This Example relates to the method for preparing the temperature sensor, comprising the following steps.

Steps 1, 2, 4, and 5 in this Example are the same as those in Embodiment 1. In step 3, the thickness ratio of the M-SWCNTr film to the PEDOT film is 1:2.

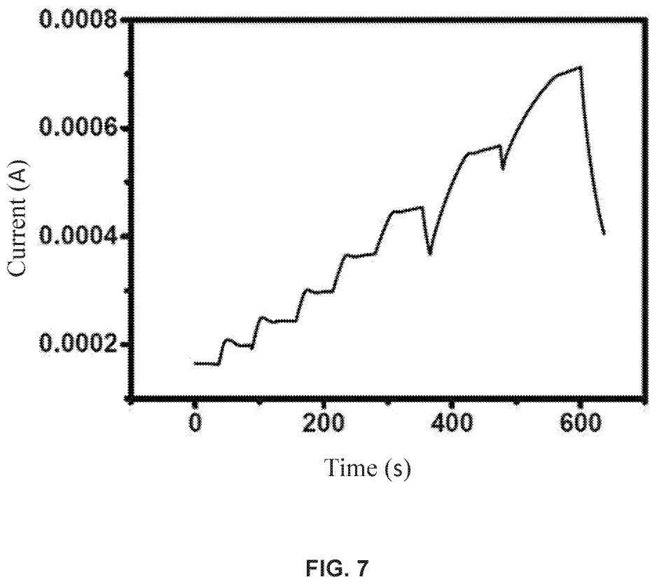

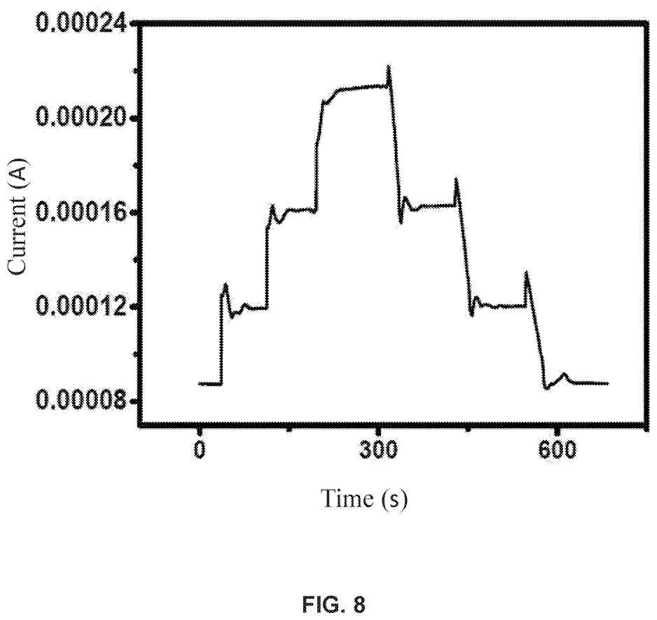

A time-current curve of the temperature sensor corresponding to Comparative Example 1 is shown in FIG. 7. The time-current curve of the corresponding temperature sensor in the temperature holding phase is shown in FIG. 8. By comparing Embodiment 1 with Comparative Example 1, it can be seen that, compared to Comparative Example 1, the response time of Comparative Example 1 becomes shorter, is more sensitive to temperature, and a temperature overshoot phenomenon may occur.

### Comparative Example 2

This Example relates to the method for preparing the temperature sensor, comprising the following steps.

Steps 1, 2, 4, and 5 of this Example are the same as those in Embodiment 1. In step 3, the thickness ratio of an M-SWCNTr film to the PEDOT film is 1:1.

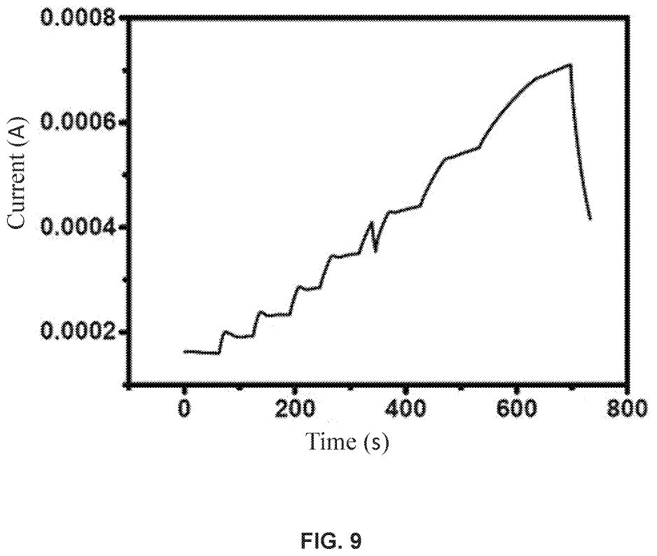

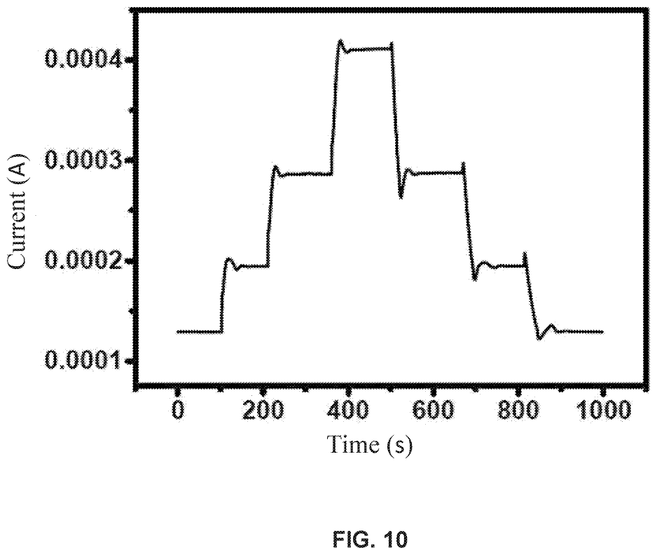

A time-current curve of the temperature sensor corresponding to Comparative Example 2 is shown in FIG. 9. The time-current curve of the corresponding temperature sensor in the temperature holding phase is shown in FIG. 10. By comparing Comparative Example 2 with Comparative Example 1, it can be seen that, compared to Comparative Example 1, the response time of Comparative Example 2 is shorter, is more sensitive to temperature, and is more prone to the temperature overshoot phenomenon.

It can be concluded from Embodiment 1, Comparative Example 1, and Comparative Example 2 that: compared to Embodiment 1, the thickness of the PEDOT film in Comparative Example 1 and Comparative Example 2 is reduced, a buffer provided thereby is reduced, and electrons can more easily reach the electrode after transitioning at an M-SWCNTr/PEDOT interface, resulting in a shorter temperature response time. At the same time, due to the excessively small thickness of the PEDOT film above the intergrown interface, moisture or dust in the air may be easily adsorbed by a side surface of the exposed PEDOT film, thereby affecting the stability of the conductivity of the material.

### Comparative Example 3

This Example relates to the method for preparing the temperature sensor, comprising the following steps.

Steps 1, 2, 4, and 5 of this Example are the same as those in Embodiment 1. In step 3, the thickness ratio of the M-SWCNTr film to the PEDOT film is 1:4.

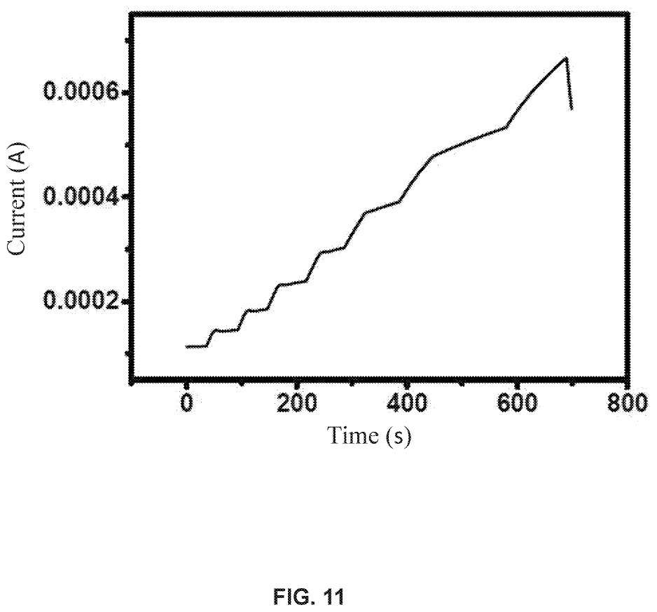

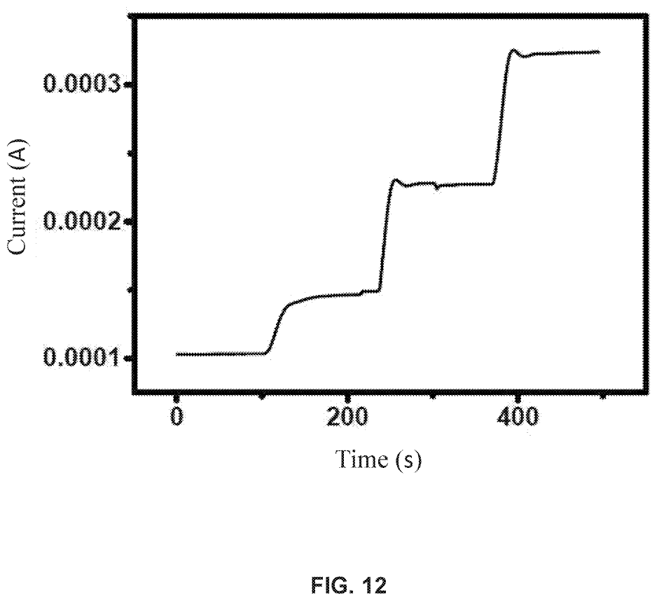

A time-current curve of the temperature sensor corresponding to Comparative Example 3 is shown in FIG. 11. The time-current curve of the corresponding temperature sensor in the temperature holding phase is shown in FIG. 12. By comparing Embodiment 1 with Comparative Example 3, it can be seen that, compared to Embodiment 1, the response time of Comparative Example 3 increases by about 30%, and the trend of change between different temperatures tends to be flatter.

### Comparative Example 4

This Example relates to the method for preparing the temperature sensor, comprising the following steps.

Steps 1, 2, 4, and 5 of this Example are the same as those in Embodiment 1. In step 3, the thickness ratio of the M-SWCNTr film to the PEDOT film is 1:5.

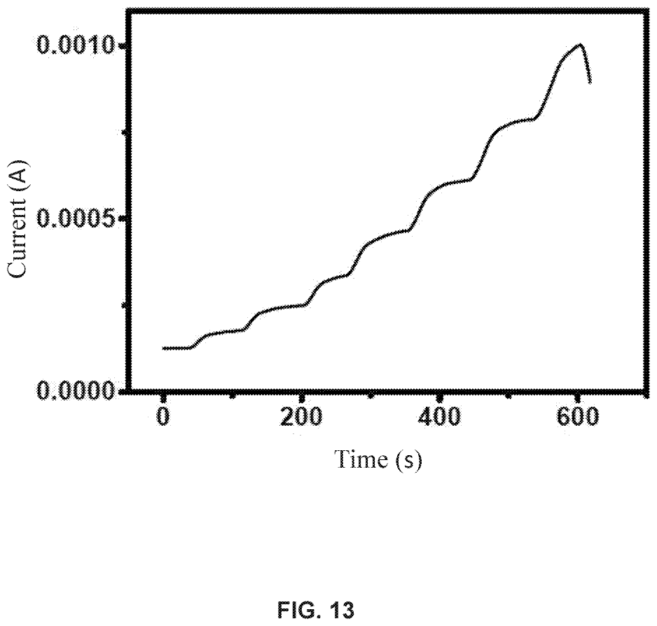

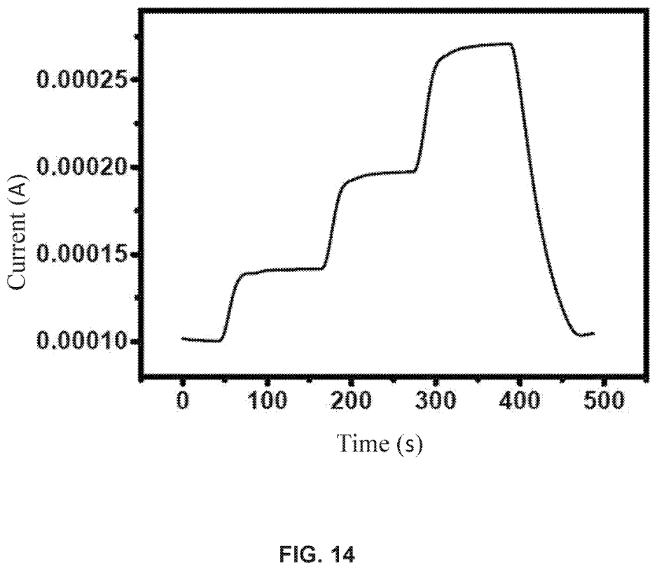

A time-current curve of the temperature sensor corresponding to Comparative Example 4 is shown in FIG. 13. A time-current curve of the corresponding temperature sensor in a temperature holding phase is shown in FIG. 14. By comparing Comparative Example 3 with Comparative Example 4, it can be seen that, compared to Comparative Example 3, the response time of Comparative Example 4 is longer, and a trend of change between different temperatures is flatter.

It can be concluded from Embodiment 1, Comparative Example 3, and Comparative Example 4 that: compared to Embodiment 1, the thickness of the PEDOT film in Comparative Example 3 and Comparative Example 4 increases, the buffer provided thereby is reduced, and electrons can less easily reach the electrode after transitioning at the M-SWCNTr/PEDOT interface. In this process, part of the thermal energy may be dissipated by the PEDOT film, resulting in a longer temperature response time.

In summary, the thicker the PEDOT film, the longer the response time of the fully flexible temperature sensor. Furthermore, the response time of the fully flexible temperature sensor is positively correlated with the thickness of the PEDOT film.

An embodiment of the present disclosure provides a temperature sensor, comprising: a thermosensitive ceramic, wherein the thermosensitive ceramic is encapsulated in the soft material, and flexible electrodes are welded on upper and lower surfaces of the thermosensitive ceramic.

In some embodiments, the temperature sensor may be a semi-flexible temperature sensor. The semi-flexible temperature sensor refers to a temperature sensor whose flexibility, ductility, or the like is between a conventional rigid temperature sensor and the fully flexible temperature sensor.

The thermosensitive ceramic refers to a ceramic material whose resistivity changes with temperature. In order to miniaturize the semi-flexible temperature sensor and to obtain a better dispersion effect in the soft material, in some embodiments, a volume of the thermosensitive ceramic may be 0.09 mm³ to 0.2 mm³. Preferably, the volume of the thermosensitive ceramic may also be 0.11 mm³ to 0.18 mm³. Preferably, the volume of the thermosensitive ceramic may also be 0.13 mm³ to 0.16 mm³. Preferably, the volume of the thermosensitive ceramic may also be 0.14 mm³ to 0.15 mm³.

The soft material refers to a material that has a lower hardness, better flexibility, and certain elasticity. In some embodiments, the soft material may include silicone gel or polyurethane (PU).

The flexible electrode refers to an electrode made of a flexible material. In some embodiments, the flexible electrodes may include gold wire, copper wire, copper foil, screen-printed silver paste, highly conductive carbon nanotube film, or highly conductive graphene. In some embodiments, the flexible electrodes may be welded on the upper and lower surfaces of the thermosensitive ceramic using conductive silver paste, gold paste, solder, or highly conductive carbon paste. By welding flexible electrodes on the thermosensitive ceramic in diversified manners, a plurality of production demands and application scenarios can be matched.

In some embodiments of the present disclosure, by setting the soft material to include silicone gel or PU and the flexible electrodes to include gold wire, copper wire, copper foil, screen-printed silver paste, highly conductive carbon nanotube film, or highly conductive graphene, an internal structure of the battery may be made flexible, thereby avoiding puncturing a battery separator and effectively preventing corrosion of an electrolyte.

In some embodiments, the semi-flexible temperature sensor may be encapsulated in an encapsulation material, and the encapsulation material may include epoxy resin, silicone gel, UV curing adhesive, PEEK, PPS, PI, or parylene. In some embodiments, the encapsulation material may also include at least one of Al₂O₃, AlN, or PTFE. More content about the encapsulation material may refer to FIG. 1A, FIG. 1B, and related descriptions thereof.

In some embodiments of the present disclosure, by providing the temperature sensor to include: a thermosensitive ceramic, wherein the thermosensitive ceramic is encapsulated in the soft material, and flexible electrodes are welded on upper and lower surfaces of the thermosensitive ceramic, a semi-flexible temperature sensor with high accuracy and good temperature sensing performance can be obtained, thereby reducing errors in an obtaining process of internal temperature distribution data of the battery.

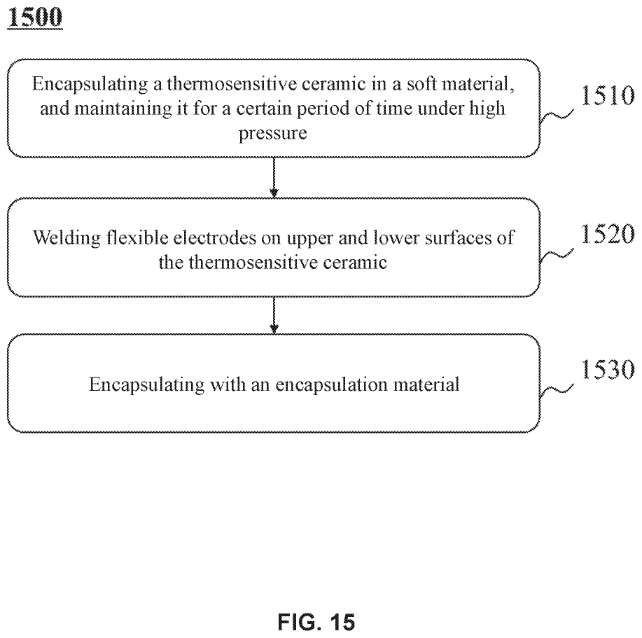

FIG. 15 is a flowchart of an exemplary method for preparing the temperature sensor according to some embodiments of the present disclosure. As shown in FIG. 15, the process 1500 includes the following steps.

Step 1510, encapsulating the thermosensitive ceramic in the soft material, and maintaining it for a certain period of time under high pressure. In some embodiments, 16 pieces of thermosensitive ceramic are encapsulated per square centimeter of the soft material. More content about the thermosensitive ceramic and the soft material may refer to the foregoing related descriptions.

In some embodiments, the high pressure may be 4 MPa to 6 MPa, and the certain period of time may be 50 days to 70 days. In some embodiments of the present disclosure, by limiting the high pressure and the corresponding time, the thermosensitive ceramic can obtain a better dispersion effect in the soft material.

Step 1520, welding flexible electrodes on upper and lower surfaces of the thermosensitive ceramic. More content about the flexible electrodes may refer to the foregoing related descriptions.

Step 1530, encapsulating with the encapsulation material. More content about the encapsulation material and the encapsulation manner may refer to FIG. 1A, FIG. 1B, and related descriptions thereof.

In some embodiments of the present disclosure, by encapsulating the thermosensitive ceramic in the soft material, maintaining it for the certain period of time under the high pressure, welding flexible electrodes on upper and lower surfaces of the thermosensitive ceramic, and encapsulating with the encapsulation material, a semi-flexible temperature sensor with excellent performance and accurate measurement can be prepared, which has high temperature sensitivity and moderate response time, thereby being able to ensure the reliability and timeliness of internal temperature collection of the battery, and enabling the battery to operate within a safe and efficient temperature range.

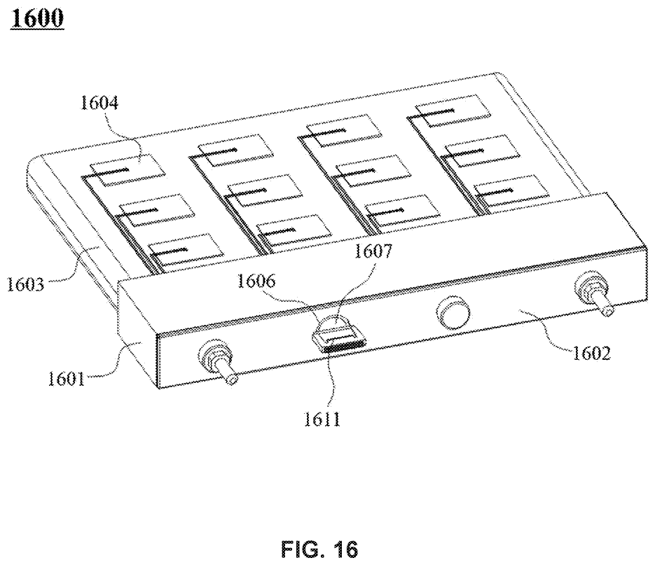

FIG. 16 is a schematic structural diagram of a battery integrated with a temperature sensor according to some embodiments of the present disclosure.

As shown in FIG. 16, the battery 1600 may include a housing 1601, a battery cell 1603, and at least one temperature sensor 1604 as described in some embodiments of the present disclosure. The housing 1601 refers to the external housing of the battery, which is configured to accommodate other components of the battery (such as the battery cover plate 1602, the battery cell 1603, the temperature sensor 1604, or the like) and isolate them from the outside world. In some embodiments, an end of the housing 1601 may be provided with the battery cover plate 1602. The battery cover plate 1602 refers to the top cover of the battery, which is configured to enclose and protect the housing of the battery. The battery cell 1603 refers to an internal electrical energy storage unit of the battery, which is configured to convert chemical energy into electrical energy during a charging and discharging process.

In some embodiments, the temperature sensor 1604 may be a fully flexible temperature sensor or a semi-flexible temperature sensor. Further details regarding the fully flexible temperature sensor may refer to FIG. 1A to FIG. 14 and related descriptions thereof. Further details regarding the semi-flexible temperature sensor may refer to FIG. 15 and related descriptions thereof. The temperature sensor 1604 may be attached to the battery cell 1603 for installation. For example, when the housing 1601 has a single battery cell 1603 inside, the temperature sensor 1604 may be disposed attached to an outer wall on one side of the battery cell 1603. When the housing 1601 has two battery cells 1603 inside, the temperature sensor 1604 may be sandwiched between the two battery cells.

In some embodiments, a number of the temperature sensors may be a plurality, the plurality of temperature sensors may be distributed in an array, and positions of the temperature sensors may constitute temperature sensing points for monitoring temperature at different positions of the battery cell. In some embodiments of the present disclosure, by adopting a plurality of temperature sensing points distributed in an array, it may be possible to achieve real-time monitoring of temperature conditions at multiple points inside the battery cell, thereby realizing real-time monitoring of a temperature distribution inside the battery and providing data support for management decisions of a BMS for the battery.

In some embodiments, a setting manner of the temperature sensor may be determined based on an application scenario. For example, when the application scenario is in fields such as electric vehicles with high safety requirements, electronic products with high user experience requirements, medical devices with high accuracy requirements, or the like, a plurality of temperature sensors may be adopted, distributed in an array at different positions of the battery cell, to form a plurality of temperature sensing points. When the application scenario is in fields such as household appliances with low accuracy requirements, power tools, or the like, one or two temperature sensors may be adopted for single-point or two-point measurement. In some embodiments, when the plurality of temperature sensors are adopted, the output temperature of the battery may be a temperature obtained by each of the temperature sensing points and a corresponding point position, or may be the highest temperature obtained among all the temperature sensing points and a corresponding point position.

In some embodiments, the temperature sensor 1604 may have a signal output terminal 1605 extending to an outside of the housing 1601. The signal output terminal 1605 refers to a terminal in the battery that can output a signal to the outside, and which is configured to transmit a signal between the battery and an external device (for example, a user terminal, or the like). In some embodiments, the signal output terminal 1605 may adopt a structure external to the battery cover plate 1602, or may adopt a structure built into the battery cover plate 1602.

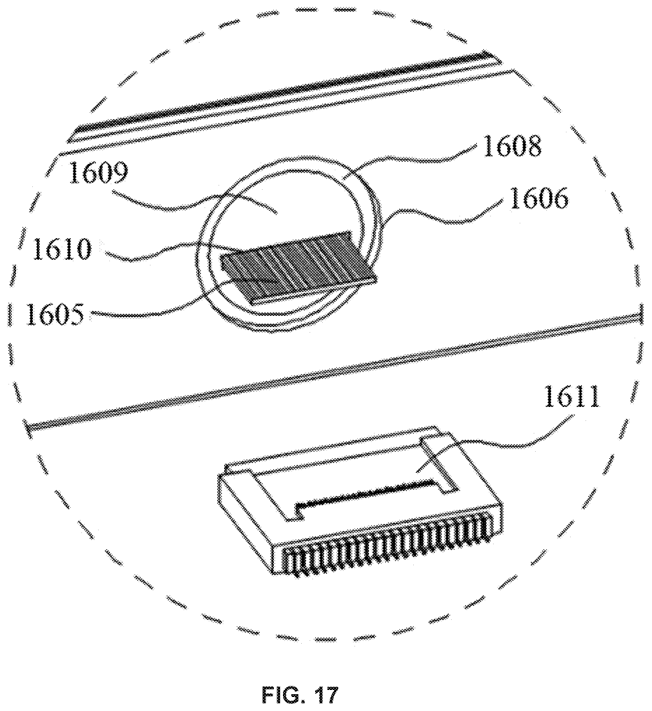

FIG. 17 is a schematic diagram of a sealing structure on a battery cover plate according to some embodiments of the present disclosure. As shown in FIG. 17, the signal output terminal 1605 adopts a structural design manner external to the battery cover plate 1602, and the quick-connection structure 1611 corresponding thereto is disposed outside the housing 1601. The quick-connection structure 1611 may be configured to realize a quick connection with an external device. Since the connection between the signal output terminal 1605 and the quick-connection structure 1611 needs to pass through the battery cover plate 1602, a high-pressure seal needs to be adopted between the signal output terminal 1605 and the battery cover plate 1602.

In some embodiments, when the signal output terminal 1605 adopts the structure external to the battery cover plate 1602, a through-hole 1606 may be provided on the battery cover plate 1602 for the signal output terminal 1605 to extend from an inside to an outside. A first sealing structure 1607 may be provided at the through-hole 1606. The first sealing structure 1607 is configured to maintain a sealing property of the signal output terminal 1605, and the first sealing structure 1607 may include a high-pressure sealing ring, a sealing member 1608, and high-pressure sealing rubber 1609. The high-pressure sealing ring is provided at an outer ring corresponding to an inner side and an outer side of the through-hole 1606, and the high-pressure sealing ring at the outer ring is fixed by a sealing nut. The sealing member 1608 is embedded in the through-hole 1606. The high-pressure sealing rubber 1609 is filled in the sealing member 1608, and a hole 1610 is provided in the high-pressure sealing rubber 1609 for the signal output terminal 1605 to pass through. A connection between the signal output terminal 1605 and the high-pressure sealing rubber 1609 is sealed by silicone gel or epoxy resin curing.

An exemplary sealing manner includes the following steps.
Step 1, providing the through-hole 1606 with a circular structure on the battery cover plate 1602. In some embodiments, a thickness of the battery cover plate 1602 may be 2 mm, and a diameter of the through-hole 1606 may be 10 mm.
Step 2, placing the high-pressure sealing ring at an inner side of the battery cover plate 1602 and an outer ring of the through-hole 1606, placing the sealing member 1608 in the through-hole 1606, placing the high-pressure sealing rubber 1609 inside the sealing member 1608, and then forming the hole 1610 with a flat shape on the high-pressure sealing rubber 1609.
Step 3, extending the signal output terminal 1605 (a printed circuit) covered with silicone gel to an outside of the battery cover plate 1602 through the hole 1610 with a flat shape, and adding silicone gel or epoxy resin curing between the signal output terminal 1605 and the high-pressure sealing rubber 1609 for curing.
Step 4, after the curing is completed, a sealing adhesive is filled into an inner side of the battery cover plate 1602 and inside the sealing member 1608, and the signal output terminal 1605 is cured again. The high-pressure sealing ring is placed outside the battery cover plate 1602 and outside the through-hole 1606, and the sealing nut is screwed on. The sealing adhesive is applied outside the sealing member 1608 to realize a sealing arrangement of the entire part.

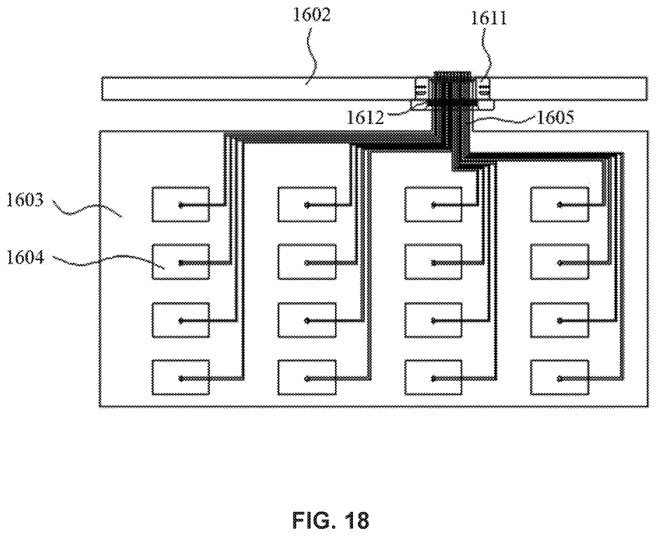

FIG. 18 is a schematic diagram of a structure for arranging a signal output terminal and a battery cover plate according to some embodiments of the present disclosure. As shown in FIG. 18, the signal output terminal 1605 adopts a structural design manner built into the battery cover plate 1602, and the quick-connection structure 1611 corresponding thereto is disposed inside the battery cover plate 1602.

In some embodiments, when the signal output terminal 1605 adopts the structure built into the battery cover plate 1602, a quick-connection structure 1611 is embedded in the battery cover plate 1602. A sealing material is filled between the quick-connection structure 1611 and the battery cover plate 1602. The signal output terminal 1605 is inserted into one end of the quick-connection structure 1611. A second sealing structure 1612 is provided at a connection position between the quick-connection structure 1611 and the signal output terminal 1605. The second sealing structure 1612 comprises the high-pressure sealing rubber.

In some embodiments of the present disclosure, by providing two structural design manners, namely the signal output terminal being external to the battery cover plate and built into the battery cover plate, the battery may be applicable to a wider range of application scenarios. Meanwhile, since the temperature sensor requires that the signal output cannot hinder the high sealing property of the battery, a sealing design is adopted at connection positions between the signal output terminal and external structures to maintain the high sealing property and to reduce an impact on battery performance.

In some embodiments, temperature data may be transmitted to a BMS system via a wireless communication manner to reduce an amount of wire harness usage and to reduce battery weight.

In some embodiments of the present disclosure, by providing a battery, which includes a housing, a battery cell, and at least one temperature sensor, wherein the temperature sensor is attached to the battery cell for installation and has a signal output terminal extending to an outside of the housing, an end of the housing is provided with a battery cover plate, and the signal output terminal adopts a structure built into the battery cover plate or a structure external to the battery cover plate, it is convenient to prepare a battery adapted to the temperature sensor in the aforementioned embodiments, thereby realizing collaborative cooperation between the two and ensuring good performance and safe operation of the battery.

The basic concepts have been described above. It is apparent to a person skilled in the art that the foregoing detailed disclosure is merely by way of example and does not constitute a limitation to the present disclosure. Although not expressly stated herein, a person skilled in the art may make various modifications, improvements, and alterations to the present disclosure. Such modifications, improvements, and alterations are suggested in the present disclosure, and thus fall within the spirit and scope of the exemplary embodiments of the present disclosure.

Additionally, the present disclosure uses specific terminology to describe the embodiments of the present disclosure. For example, ‘an embodiment’, ‘one embodiment’, and/or ‘some embodiments’ mean a certain feature, structure, or characteristic associated with at least one embodiment of the present disclosure. Therefore, it should be emphasized and noted that the phrases ‘one embodiment’ or ‘an embodiment’ or ‘an alternative embodiment’ mentioned twice or more times at different positions in the present disclosure do not necessarily refer to the same embodiment. Furthermore, certain features, structures, or characteristics in one or more embodiments of the present disclosure may be appropriately combined.

Moreover, unless explicitly stated in the claims, the order of processing elements and sequences described in the present disclosure, the use of numerals and letters, or the use of other names, is not intended to limit the order of processes and manners of the present disclosure. Although some presently useful inventive embodiments have been discussed through various examples in the foregoing disclosure, it should be understood that such details are merely by way of example. The appended claims are not limited to the disclosed embodiments; on the contrary, the claims are intended to cover all modifications and equivalent combinations that fall within the spirit and scope of the embodiments of the present disclosure. For example, although the system components described above may be implemented by hardware devices, implementation may also be achieved solely by software solutions, for example, by installing the described system on an existing server or a mobile device.

Similarly, it should be noted that, to simplify the description of the present disclosure and to aid in the understanding of one or more inventive embodiments, in the foregoing description of the embodiments of the present disclosure, various features may sometimes be grouped together into a single embodiment, drawing, or description thereof. However, this manner of disclosure does not mean that features required by the subject matter of the present disclosure are more numerous than the features recited in the claims. Indeed, the features of an embodiment are fewer than all the features of a single embodiment described above.

In some embodiments, numbers describing quantities of components and attributes are used, and it should be understood that such numbers used for the description of the embodiments are, in some examples, modified by the terms ‘about’, ‘approximately’, or ‘substantially’. Unless otherwise specified, ‘about’, ‘approximately’, or ‘substantially’ indicate that the stated numbers allow a variation of ±20%. Accordingly, in some embodiments, the numerical parameters used in the description and claims are all approximate values, and these approximate values may vary depending on characteristics required by individual embodiments. In some embodiments, the numerical parameters should consider the specified significant digits and use a general manner of rounding. Although numerical ranges and parameters used in some embodiments of the present disclosure to confirm their breadth of scope are approximate values, in specific embodiments, the settings of such values are made as precisely as possible within a feasible range.

For each patent, patent application, patent application publication, and other materials cited in the present disclosure, such as articles, books, manuals, publications, documents, or the like, their entire contents are hereby incorporated by reference into the present disclosure. Except for any prosecution history documents that are inconsistent with or conflict with the contents of the present disclosure, and except for any documents (currently or later appended to the present disclosure) that limit the broadest scope of the claims of the present disclosure. It should be noted that if descriptions, definitions, and/or uses of terms in the materials appended to the present disclosure are inconsistent with or conflict with the content described in the present disclosure, the descriptions, definitions, and/or uses of terms in the present disclosure shall prevail.

Finally, it should be understood that the embodiments described in the present disclosure are merely by way of example to illustrate the principles of the embodiments of the present disclosure. Other variations may also fall within the scope of the present disclosure. Therefore, by way of example and not limitation, alternative configurations of the embodiments of the present disclosure may be considered consistent with the teachings of the present disclosure. Accordingly, the embodiments of the present disclosure are not limited to the embodiments expressly introduced and described in the present disclosure.

What is claimed is:

1. A temperature sensor, comprising:
a bottom electrode and a top electrode; and
a poly(3,4-ethylenedioxythiophene) (PEDOT) film and a carbon nanotube film that are intergrown and disposed between the bottom electrode and the top electrode.

2. The temperature sensor according to claim 1, wherein a thickness ratio of the carbon nanotube film to the PEDOT film is 1:(2.4 to 3.6).

3. The temperature sensor according to claim 2, wherein the thickness ratio of the carbon nanotube film to the PEDOT film is 1:3.

4. The temperature sensor according to claim 2, wherein a thickness of the carbon nanotube film is 0.01 mm to 0.05 mm.

5. The temperature sensor according to claim 4, wherein the thickness of the carbon nanotube film is 0.03 mm.

6. The temperature sensor according to claim 1, wherein the bottom electrode, the top electrode, and the intergrown poly(3,4-ethylenedioxythiophene) film and carbon nanotube film are encapsulated in an encapsulation material, and the encapsulation material comprises at least one of epoxy resin, silicone gel, ultraviolet (UV) curing adhesive, polyether ether ketone (PEEK), polyphenylene sulfide (PPS), polyimide (PI), or parylene.

7. The temperature sensor according to claim 6, wherein the encapsulation material further comprises at least one of aluminum oxide (Al₂O₃), aluminum nitride (AlN), or polytetrafluoroethylene (PTFE).

8. The temperature sensor according to claim 1, wherein a thickness of the temperature sensor is 0.3 mm to 0.6 mm.

9. The temperature sensor according to claim 1, wherein an interface is formed between the intergrown poly(3,4-ethylenedioxythiophene) film and the carbon nanotube film for electron transition upon thermal excitation.

10. The temperature sensor according to claim 9, wherein an area of the interface is positively correlated with a temperature sensitivity of the temperature sensor.

11. The temperature sensor according to claim 1, wherein a response time of the temperature sensor is positively correlated with a thickness of the poly(3,4-ethylenedioxythiophene) film.

12. The temperature sensor according to claim 1, wherein
carbon nanotubes of the carbon nanotube film are selected from high-purity single-walled carbon nanotubes; and
the bottom electrode and the top electrode are selected from a carbon nanotube film electrode material, a graphene film electrode material, a screen-printed silver paste electrode material, copper foil, or a flexible printed circuit (FPC) electrode.

13. The temperature sensor according to claim 1, wherein the bottom electrode is formed on a substrate, and the substrate is selected from silicon, a mica sheet, or a polymeric material.

14. A method for preparing the temperature sensor according to claim 1, comprising:
forming the bottom electrode on a substrate;
dispersing carbon nanotubes in a medium solution, and forming the carbon nanotube film on the bottom electrode by a certain method;
growing the poly(3,4-ethylenedioxythiophene) film on a surface of the carbon nanotube film by a chemical vapor deposition (CVD) method;
placing the top electrode on the poly(3,4-ethylenedioxythiophene) film; and
encapsulating with an encapsulation material.

15. The method according to claim 14, wherein the certain method comprises suction filtration, spraying, or film formation.

16. The method according to claim 14, wherein the medium solution comprises an organic solvent or water, a number of dispersion times is not less than 5, each dispersion time is not less than 30 s, and an ambient temperature is 20 °C to 30 °C.

17. A battery, comprising a housing, a battery cell, and at least one temperature sensor including the temperature sensor according to claim 1, wherein
the at least one temperature sensor is attached to the battery cell and has a signal output terminal extending to an outside of the housing;
a battery cover plate is provided at an end of the housing, and the signal output terminal adopts a structure built into the battery cover plate or a structure external to the battery cover plate.

18. The battery according to claim 17, wherein a number of the at least one temperature sensor is a plurality, the plurality of temperature sensors are distributed in an array, and positions of the plurality of temperature sensors constitute temperature sensing points for monitoring temperature at different positions of the battery cell.

19. The battery according to claim 17, wherein when the signal output terminal adopts the structure external to the battery cover plate,
a through-hole is provided on the battery cover plate for the signal output terminal to extend from an inside to an outside, a first sealing structure is provided at the through-hole, the first sealing structure is configured to maintain a sealing property of the signal output terminal, and the first sealing structure comprises a high-pressure sealing ring, a sealing member, and high-pressure sealing rubber;
the high-pressure sealing ring is provided at an outer ring corresponding to an inner side and an outer side of the through-hole, and the high-pressure sealing ring at the outer ring is fixed by a sealing nut, the sealing member is embedded in the through-hole, the high-pressure sealing rubber is filled in the sealing member, a hole is provided in the high-pressure sealing rubber for the signal output terminal to pass through, and a connection between the signal output terminal and the high-pressure sealing rubber is sealed by silicone gel or epoxy resin curing.

20. The battery according to claim 17, wherein when the signal output terminal adopts the structure built into the battery cover plate,
a quick-connection structure is embedded in the battery cover plate, and a sealing material is filled between the quick-connection structure and the battery cover plate;
the signal output terminal is inserted into one end of the quick-connection structure, a second sealing structure is provided at a connection position between the quick-connection structure and the signal output terminal, and the second sealing structure comprises high-pressure sealing rubber.
